(19) United States
(12) Patent Application Publication
(10) Pub. No.: US 2026/0358123 A1
(43) Pub. Date: Nov. 12, 2026

(54) METHOD AND SYSTEM FOR MEASURING WATER CHARACTERISTICS IN MANAGED CANALS

(71) Applicant: Salt River Project Agricultural Improvement and Power District, Tempe, AZ (US)

(72) Inventors: Chad Palmer, Gilbert, AZ (US); Steven Mansour, Gilbert, AZ (US); Jonathan Lind-Savage, Chandler, AZ (US); Joseph Clonch, Buckeye, AZ (US); Matthew Mitchell, Glendale, AZ (US)

(73) Assignee: Salt River Project Agricultural Improvement and Power District, Tempe, AZ (US)

(21) Appl. No.: 19/669,272

(22) Filed: May 6, 2026

Related U.S. Application Data
(60) Provisional application No. 63/801,009, filed on May 6, 2025.

(51) Int. Cl. G01C 13/00; G01K 1/02; G01K 1/024; G01K 13/02

(52) U.S. Cl. CPC G01C 13/008; G01K 1/024; G01K 1/026; G01K 13/026

(57) ABSTRACT

Methods and apparatus for measuring water characteristics in a managed canal according to various aspects of the present technology comprise a system for collecting both localized environmental data and direct measurements of in-water conditions to provide a set of data that can be used to estimate evaporation of flowing water from an open canal. A first data collection device may be extended out over the canal at a specified location to collect canal data at that location. A second data collection device may extend into the canal itself to collect data specific to in-water conditions at the same location. A third data collection device may be used to collect environmental data in the immediate proximity of the selected location. Data from each collection device may be received at specified intervals to allow for continuous monitoring and estimation of evaporation rates.

### CROSS-REFERENCE TO RELATED APPLICATIONS

This application claims the benefit of U.S. Provisional Patent Application No. 63/801,009, filed May 6, 2025, and incorporates its disclosure by reference.

### BACKGROUND OF TECHNOLOGY

There are numerous canals in the United States used to transport water from a source location to a use location. Open channel canal systems are a vital component of water delivery systems because they allow for the transport of water supplies for irrigation, industry, and municipal use. The ability to manage or better monitor the water supply delivered via canals is especially critical in arid regions that rely heavily on limited water sources to sustain its population, agriculture, and ecosystems. Existing methods for estimating canal evaporation typically do not involve measurements of actual conditions within specific canal sections, and there are very limited accurate historical data on evaporation of flowing water in open canals. Methods currently in use often lack consistency and require manual data collection, which can lead to irregular reporting, unreliable data, and delayed results.

### SUMMARY OF THE TECHNOLOGY

Methods and apparatus for measuring water characteristics in a managed canal according to various aspects of the present technology comprise a system for collecting both localized environmental data and direct measurements of in-water conditions to provide a set of data that can be used to estimate evaporation of flowing water from an open canal. A first data collection device may be extended out over the canal at a specified location to collect canal data at that location. A second data collection device may extend into the canal itself to collect data specific to in-water conditions at the same location. A third data collection device may be used to collect environmental data in the immediate proximity of the selected location. Data from each collection device may be received at specified intervals to allow for continuous monitoring and estimation of evaporation rates.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1 representatively illustrates a system for measuring water characteristics in a managed canal in accordance with an exemplary embodiment of the present technology;

FIG. 2 representatively illustrates a side view of the system for measuring water characteristics in a managed canal shown in FIG. 1 in accordance with an exemplary embodiment of the present technology;

FIG. 3 representatively illustrates a flow chart of a data collection and analysis process in accordance with an exemplary embodiment of the present technology;

FIG. 4 representatively illustrates a tube extending into a canal in accordance with an exemplary embodiment of the present technology; and

FIG. 5 representatively illustrates a detailed interior view of an end of the tube shown in FIG. 4 in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of materials, electronics, transmitters, sensors, receivers, radios, power supplies, communication devices, framing support, and safety features. In addition, the present technology may be practiced in conjunction with any number of radio equipment or other communication devices, and the system described is merely one exemplary application for the technology. Methods and system for measuring water characteristics in a managed canal according to various aspects of the present technology may operate in conjunction with any suitable communication equipment such as a wireless radio transmitters, receivers, wireless hubs, nodes, servers, fiber optic cable, ethernet devices, and other wireless or wired communication equipment.

The present technology describes a system that addresses challenges in open channel environmental monitoring and water management systems by providing an innovative, all-in-one suite of instrumentation for a more accurate measurement of water characteristics, localized weather data, and evaporation rates in flowing canals. The disclosed system integrates various types of atmospheric and water sensors into a single platform, enabling comprehensive analysis of factors that can influence evaporation. Various embodiments of the system enable automated data collection, transmission of collected data, and may help promote sustainability and reduced operational costs, making the system suitable for data collection in remote locations by offering an option for off-grid regenerative power sources. Real-time data logging capabilities ensure that users have access to up-to-date information, facilitating timely decision-making in water management practices. The disclosed technology may enhance the understanding of evaporation dynamics. Quantification of this information also supports efforts toward more sustainable water resource management in the face of growing environmental concerns.

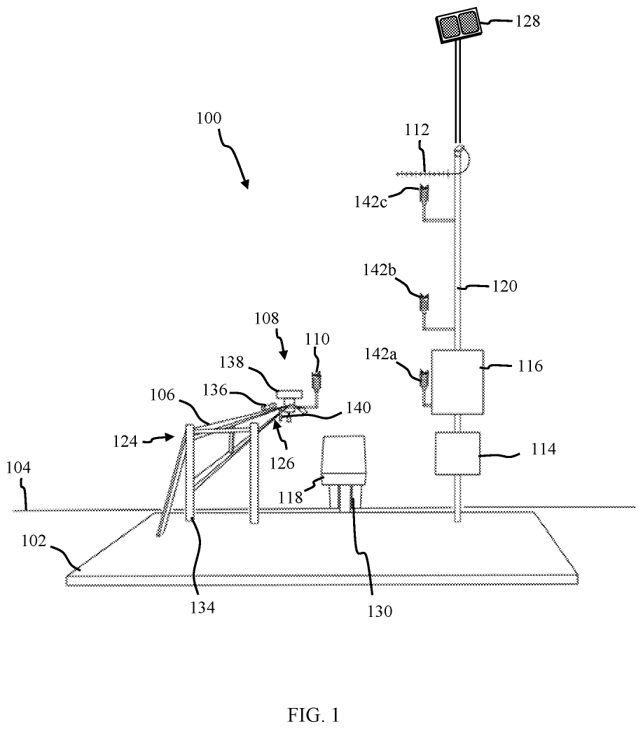

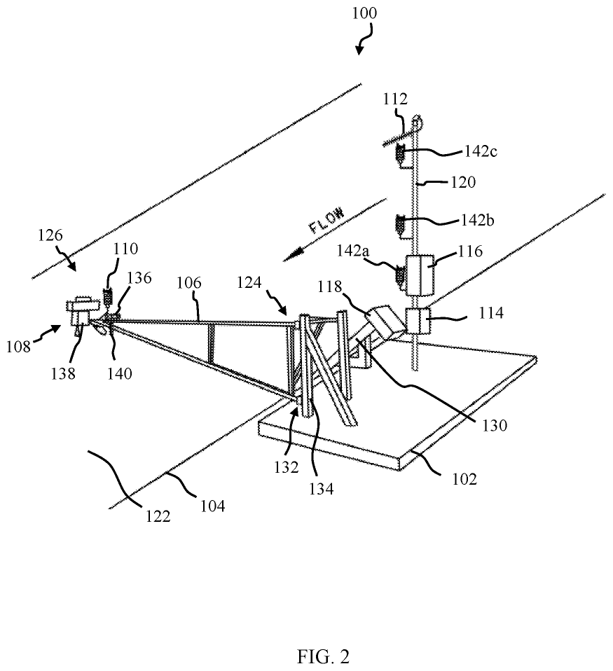

Referring now to FIGS. 1 and 2, a system for measuring water characteristics in a managed canal 100 may comprise a base 102 positioned along a canal bank 104. A plurality of instruments, sensors, housings, controllers, and communication devices may be secured to the base 102 at various locations to facilitate the collection of data, storage of data, and communication of the data to a remote location. The placement or location of each type of sensor or data collection device may be determined according to any suitable criteria relevant to the type of data being collected. For example, sensors adapted to collect water specific data may be located or positioned in a manner relative to the canal to allow for a direct unobstructed measurement. Other sensors adapted to collect data associated with general ambient conditions may be positioned at any suitable location on the base.

In one representative embodiment, an instrument arm 106 may be coupled to the base 102 at a first end 124 and extend out over the canal 122. A first data collection system comprising a first plurality of sensors 108 may be positioned above a surface of the canal 122 at or proximate to a second end 126 of the instrument arm 106. The plurality of sensors 108 may comprise any suitable devices or systems for collecting, measuring, or otherwise acquiring water characteristic data such as surface temperature, radiation, flow rate, depth and ambient environmental conditions.

A second data collection device 118 may be coupled to the base and be configured to extend downwardly from the canal bank 104 into the canal 122 itself. The second data collection device 118 may include a second plurality of instruments, sensors, housings, controllers, and communication devices (not shown) that are adapted to collect data from below a surface level of the canal. A third plurality of instruments, sensors, housings, controllers, and communication devices may be connected to a mast 120 extending upwards from the base 102.

The base 102 may comprise any suitable system or device for providing a stable mounting location for the instrument arm 106, second data collection device 118, and the mast 120. For example, in one embodiment, the base 102 may comprise a concrete pad disposed along the canal bank 104 having dimensions selected to provide adequate support for the instruments, sensors, housings, controllers, and communication devices connected to the base 102. The base 102 may also be configured to be positioned within an existing footprint so as not to require any additional site modifications. For example, the base 102 may be sized to fit between an existing service road and the canal bank 104. In some embodiments, the base 102 may require a thicker pad that extends deeper into the ground to accommodate a smaller surface footprint due to preexisting structures or other space limitations.

The instrument arm 106 may be configured in any suitable manner to position the first plurality of sensors 108 in a desired location over the canal 122. For example, the instrument arm 106 may comprise a length suitable for positioning the first plurality of sensors 108 at a position substantially equidistant from opposing sides of the canal 122. Alternatively, the length of the instrument arm 106 may be adjustable to facilitate locating the plurality of sensors 108 at a preferred location over the canal, such as above the deepest point in the canal 122 or at a predetermined distance from the canal bank 104.

The first end 124 of the instrument arm 106 may be coupled to the base 102 by any suitable manner. For example, in a first embodiment, the instrument arm 106 may be connected to a mounting structure 134 fixedly attached to the base 102. A pair of couplings 132 may allow the instrument arm 106 to rotate or pivot about the mounting structure 134 to allow the first plurality of instruments 108 to be repositioned to the canal bank 104 for servicing if necessary.

The first plurality of sensors 108 may be used to collect data specific to conditions within the canal 122. The first plurality of sensors 108 may comprise any suitable collection or group of device types for collecting data, recording an event such as with audio or video, or saving or transmitting collected data. In some embodiments, each sensor from the first plurality of sensors 108 may be configured to wirelessly transmit collected to another device, such as a data logger. In another embodiment, one or more sensors from the first plurality of sensors 108 may be configured to transmit data through a wired connection or save data locally to the specific device so that it can be accessed at another time.

Each sensor from the first plurality of sensors 108 may also be configured to collect data over any specified time period, time interval, or at a prescribed time. For example, each sensor from the first plurality of sensors 108 may be configured to collect data at 1 minute intervals and communicate the collected data to a remote data logger. In another embodiment, a portion of sensors from the first plurality of sensors 108 may be configured to collect data at a first time interval and a second portion of sensors may be configured to collected data at a second time interval.

The first plurality of sensors 108 may be selected according to the type of data that is intended to be collected from the canal 122. Certain criteria based on water specific conditions may be useful in calculating evaporation from the canal 122. For example, a flow rate of water in the canal 122 may be required. Therefore, one type of sensor positioned at the second end 126 of the instrument arm 106 may comprise a flow meter 138. The flow meter 138 may comprise any suitable device for measuring a flow rate of water in the canal 122. In one embodiment, the flow meter 138 may be configured to extend downward into the canal 122 to allow the flow meter 138 to measure a rate in which water is flowing past the flow meter 138.

In another embodiment, the flow meter 138 may be configured to measure the flow rate of the canal 122 without requiring direct contact between the flow meter 138 and the water. For example, the flow meter 138 may be configured to use a non-contact method of measuring velocity such as radar, sonar, laser, or an ultrasonic measurement device. A non-contact measurement device may positioned on the instrument arm 106 such that it is facing in a substantially downward orientation towards the surface of the canal 122. The flow meter 138 may also be configured to account for and correct for conditions that may cause inaccuracies in measured flow rates such as ambient temperature, light conditions, or vibration of the instrument arm 106.

The first plurality of sensors 108 may also include a weather station 110 configured to collect ambient environmental data at the location of the second end 126 of the instrument arm 106 proximate the surface of the canal 122. The weather station 110 may comprise any device for system of devices for collecting environmental data such as temperature, wind speed, wind direction, humidity, air pressure, rainfall, and the like. The weather station 110 may be positioned on the instrument arm 106 in a manner that reduces a potential for inaccurate measurements from the other components and devices connected to the base 102.

The first plurality of sensors 108 may also comprise a radiometer 136 configured to measure radiation from the surface of the canal 122. The radiometer 136 may comprise any suitable device for measuring one or more types of radiation at or near the surface level of the canal 122. In one embodiment, the radiometer 136 may be configured to measure radiation in at least two different bands along an electromagnetic spectrum. For example, the radiometer 136 may be configured to measure a first band of solar radiation between about 300 nm and about 2,800 nm and a second band of near infrared radiation in the range of about 4,500 nm to about 42,000 nm.

A depth sensor 140 may also be included within the first plurality of sensors 108 and be configured to measure a depth of the water in the canal 122. Similar to the flow meter 138, the depth sensor 140 may be configured to determine a depth of the canal 122 either through direct measurement or through a non-contact method. For example, in one embodiment, the depth sensor 140 may comprise a radar based system configured to direct radar waves downwardly into the canal to determine the depth of the water in the canal 122.

Other types of sensors such an audio or video recorder or motion sensor may be included within the first plurality of sensors 108 to further monitor the localized area. For example, a video camera may be connected to the second end 126 of the instrument arm 106 to monitor upstream and downstream conditions.

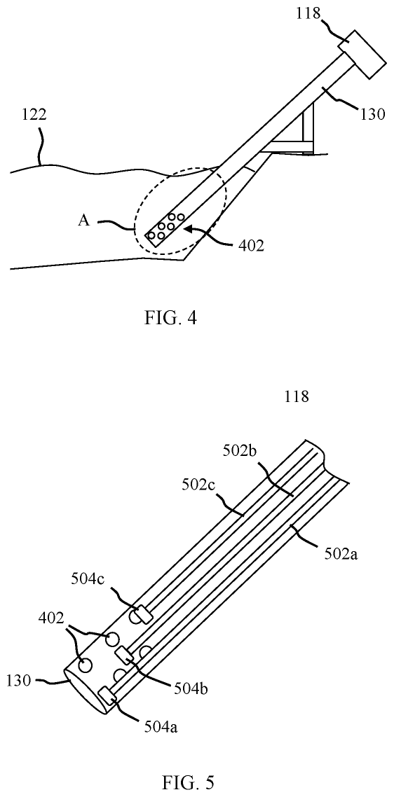

A secondary sensor suite 118 may also be coupled to the base 102 and include additional sensors configured to collect additional water characteristic data. For example and referring now to FIGS. 4 and 5, the secondary sensor suite 118 may comprise a series of temperature probes 504a-504c configured to extend into the canal 122. The temperature probes 504a-504c may comprise any suitable device for measuring water temperature such as a thermistor, a thermometer, a thermocouple, an infrared sensor, and the like.

In one embodiment the temperature probes 504a-504c may be installed within a tube 130 and be positioned between about 6 inches and about 22 inches apart from each other along an interior portion of tube 130 such that they are located at different depths within the canal 122. The temperature probes 504a-504c may also be lowered into the canal by one or more predetermined distances to allow for the collection of temperature data at various depths of the canal. For example, a first temperature probe 504a may be positioned at an end of a first extension tube 502a positioned within the tube 130 at or near a bottom of the canal 122 to obtain a temperature reading at that location. A second temperature probe 504b may be positioned at an end of a second extension tube 502b further up the tube 130 to obtain a temperature reading at a first distance above the bottom of the canal 122. A third temperature probe 504c may be positioned at an end of a third extension tube 502c within the tube 130 to obtain a temperature reading at a location nearer the surface of the canal 122 than that of the second temperature probe 504b. One of skill in the art will recognize that additional temperature probes may be likewise installed within the tube 130 to obtain any desired number of temperature readings between the surface of the canal 122 and the bottom of the canal 122.

The tube 130 may be configured to allow water flowing in the canal 122 to enter into an interior portion of the tube 130 so that the temperature probes are able to obtain a reading at each depth. For example, the tube 130 may include perforations 402 configured to allow water to flow into and out of the interior of the tube 130. The perforations may comprise any suitable size, shape, or number to facilitate the flow of water through the tube 130.

The interior of the tube 130 may also comprise one or more sensor locators configured to fix the position of each temperature probe within the tube 130. By fixing the location of each temperature probe within the tube 130 it may be possible to avoid variances in data collection that could arise if one or more temperature probes have to be replaced over time. For example, if a temperature probe fails and requires replacement, it may be important that the replacement probe is located at the exact same position within the tube 130 so that data collected from that sensor isn't subject to variation from prior collected data due to being located a slightly different depth within the canal 122 than the replaced sensor. In one embodiment, the extension tubes 502a-502c may be configured to be removed from the interior of the tube 103 with their corresponding temperature probe 502. If each extension tube 502 comprises a different length from the remaining extension tubes 502, then if a given extension tube 502 and temperature probe 504 are removed and replaced, the temperature probe 504 will be located at the same depth as it was prior to being removed.

A mast 120 may extend upwardly from the base 102 and include other electronics such as data loggers, controllers, communication devices, antennas, or any other suitable equipment. For example, a power supply 114 may be connected to the mast 120 and be configured to provide electricity to the first plurality of sensors 108, the secondary sensor suite 118, a data logging system 116, a plurality of second weather stations 142a, 142b, 142c and any communications devices 112. The power supply 114 may comprise any suitable system or device for supplying the required power needed by the system. In one embodiment, the power supply 114 may comprise a power terminal configured to be connected to an established power grid or local power source, which allows for remote and manual control for data collection. In another embodiment, the power supply 114 may be coupled to one or more renewable energy sources such as a solar array 128, wind turbine, and a battery system configured to store any generated power from the renewable energy sources or from a connected electrical grid.

The mast 120 may also be configured to locate the plurality of second weather stations 142a, 142b, 142c at varying heights along the mast 120 to collect slight variations in environmental conditions in the immediate area. In one embodiment, a first mast weather station 142a may be located at a first height of about 4-8 feet above the base 102. A second mast weather station 142b and a third mast weather station 142c may be located higher up on the mast 120 at predetermined distances from each other. In one embodiment, the second and third mast weather stations 142b, 142c may be positioned at higher locations along the mast 120 such that a distance between each successive mast weather station 142a, 142b, 142c is the same. For example, the first mast weather station 142a may be positioned at 5 feet above the base 102, the second mast weather station 142b may be positioned at 10 feet above the base 102, and the third mast weather station 142c may be positioned at 15 feet above the base 102.

In a first representative embodiment, the mast weather stations 142a, 142b, 142c may comprise the same type of weather station as the weather station 110 located on the instrument arm 106. This may reduce the chance of variation between collected data and provide a more representative sample of variations in the environmental data at each location. Alternatively, the mast weather stations 142a, 142b, 142c comprise a different type of environmental data sensors to provide a more accurate distinction between collected data at each height irrespective the data collected directly over the canal 122.

The mast 120 may also be configured to position each mast weather station 142a, 142b, 142c in a manner that they are less likely to cause interference with each other. For example, if the mast weather stations 142a, 142b, 142c were positioned directly over each other, mast weather stations 142 located lower on the mast 120 may not record the same level of rainfall as the highest mounted mast weather station 142. Therefore, the mast weather stations 142a, 142b, 142c may be rotated about a vertical axis of the mast 120 relative to each other. For example, the second mast weather station 142b may be rotated about the mast 120 by a first angular degree relative to the first mast weather station 142a and the third mast weather station 142c may be rotated further around the mast 120 by a second angular degree such that no single mast weather station 142 is located directly above another mast weather station 142.

The data logging system 116 may comprise any suitable system for storing collected water characteristic data and controlling one or more sensors. For example, the data logging system 116 may comprise a programmable logic controller configured to solicit data from one or more sensors on a predetermined interval. Received data may then be saved to a local storage device or transmitted to a remote data storage system via the communication device 112.

The communication device 112 may comprise any suitable device or system for transmitting data to a remote location. In some embodiments, the communication device may comprise a transceiver and an antenna configured to communicate over a wireless communication system. In another representative embodiment, the communication device 112 may be configured to communicate over a wired connection such as over a co-axial or fiberoptic cable.

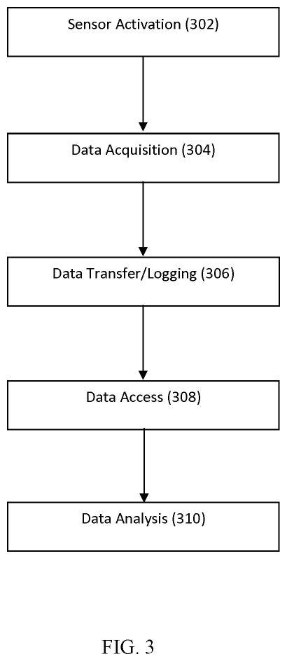

With reference now to FIG. 3, once activated (302) the system 100 may be configured to collect water characteristic data (304) based on a set of predetermined criteria. For example, water temperature data, water flow rate, radiation, and local environmental data may be collected on a set time interval. The time interval may be determined according to any suitable criteria such as a desired time period or according to a polling capacity of a given piece of equipment. Other data may be collected more sporadically or according to other criteria than time such as changing weather or other environmental conditions.

As water characteristic data is collected, it may be transferred or otherwise communicated from a given sensor to the data logging system 116 (306) where the data may be stored, processed, or communicated to one or more other systems. Collected data may then be accessed by one or more users by any suitable method (308). For example, the data logging system 116 may be communicatively linked to a remote server or cloud-based application system that may be accessed by a user through an application software system.

Stored/collected data may then be further processed or analyzed (310) to determine accurate water conditions for the canal at one or more locations where a system for measuring water characteristics in a managed canal 100 has been installed. To estimate water evaporation from the canal 122, data inputs such as water temperature, latent heat energy of the canal 122, and environmental conditions such as wind speed may be used. In one embodiment, latent heat flux may be calculated from collected data and used to estimate evaporation rates within the canal 122. For example, latent heat flux may be calculated using the Penman-Brutsaert equation:

$$Latent heat flux , λE = \frac{Δ}{Δ + y *} ( {R}_{n} - U ) + \frac{Y *}{Δ + y *} {E}_{A} \qquad Eq . ( 1 )$$

where Rₙ is net radiation, U is heat flux into the canal, and E_{A} is atmospheric drying as a function of wind speed and relative humidity. To determine potential evaporation within the canal 122, Eq. 1 may be rewritten as:

$$\text{?} \qquad Eq . ( 2 )$$

$$\text{?} \text{indicates text missing or illegible when filed}$$

where E_{P} is the potential evaporation from the canal 122, W is a dimensionless weighing function where

$$W = \frac{Δ}{Δ + γ *}$$

and Δ is equal to the slope of a saturation vapor curve as a function of temperature, and γ* is a psychrometric constant based on latent heat vaporization and the heat capacity of dry air.

Heat flux available for evaporation is provided by Rₙ−U, where:

$$U = - λ ( \frac{Δ T}{Δ z} ) = - λ \frac{( {T}_{2} - {T}_{1} )}{( {z}_{2} - {z}_{1} )} \qquad Eq . ( 3 )$$

where z₁ is a first depth within the canal 122, z₂ is a second depth within the canal 122, T₁ is the temperature at z₁, and T₂ is the temperature at z₂. It can be seen that obtaining consistent data from known positions within the canal may improve the accuracy of determining an accurate value for the available heat flux.

Atmospheric drying E_{A}, may require measurement of localized environmental data to determine the impact on evaporations rates. E_{A} may be determined according to:

$${E}_{A} = ku * ρ ( q * - {q}_{a} ) {( ln [ \frac{z - {d}_{ov}}{{z}_{ov}} ] - {ψ}_{v} [ \frac{z - {d}_{ov}}{L} ] )}^{- 1} \qquad Eq . ( 4 )$$

where:
von Karman's constant, k=0.4
friction velocity,

$$u *= {( \frac{{τ}_{0}}{ρ} )}^{1 / 2}$$

surface shear stress τ₀=ρC_{d}u²
u=wind speed

$$( \frac{m}{s} )$$

at lowest height
ρ(Tₐ)=air density dependent on air temperature
drag coefficient, C_{d}=(a+bu)·10⁻³
for calm water: a=0.001 and b=0.0063
for ocean in neutral conditions:
C_{d}=(0.75+0.67 u)·10⁻³
q*=specific humidity of air
qₐ=saturation specific humidity at air temperature
displacement height for water vapor, d₀ᵥ≈0
z=height of measurement above surface
z₀ᵥ=vapor roughness height
For smooth open water: z₀ᵥ=(10⁻³, 10⁻⁴] m
Monin-Obukhov similarity stability correction function,

$${ψ}_{v} = \frac{z - {d}_{ov}}{L}$$

Obukhov length,

$$L = - \frac{{u}_{*}^{3}}{kg [ \frac{{H}_{v}}{{ρ c}_{p} {T}_{a}} ]}$$

if L<0, then unstable
if L>0, then stable
if |Z|≥100, then neutral conditions
Specific flux of virtual sensible heat at the surface, Hᵥ=H+0.61 TₐcₚE_{P}
H=sensible heat flux [W/m²]
Tₐ=air temperature at lowest height
cₚ=specific heat at constant pressure
   such that the result presents:
5 equations with 5 unknowns: Eₚ, E_{A}, H, L, u,

$${E}_{p} = W ( {R}_{n} - U ) + ( 1 - W ) {E}_{A} \qquad ( 1 )$$

$${E}_{A} = k u * ρ ( q * - {q}_{a} ) {( ln [ \frac{z - {d}_{ov}}{{z}_{ov}} ] - {ψ}_{v} [ \frac{z - {d}_{ov}}{L} ] )}^{- 1} \qquad ( 2 )$$

$$L = \frac{- {u}_{*}^{3}}{kg ( \frac{{H}_{v}}{{ρ c}_{p} {T}_{a}} )} \qquad ( 3 )$$

$$V = \frac{u *}{k} [ ln ( \frac{z - {d}_{o}}{{z}_{o}} ) - {ψ}_{m} ( \frac{z - {d}_{o}}{L} ) ] \qquad ( 4 )$$

$${ψ}_{m} = ln [ \frac{{( 1 + x )}^{2} \cdot ( 1 + {x}^{2} )}{{( 1 + {x}_{0} )}^{2} \cdot ( 1 + {x}_{0}^{2} )} ] - 2 arctan ( x ) + 2 arctan ( {x}_{0} )$$

$$x = {( 1 - 16 y )}^{\frac{1}{4}} , y = \frac{z - {d}_{ov}}{L} , {x}_{0} = {( \frac{1 - 16 {z}_{o}}{L} )}^{\frac{1}{4}}$$

momentum displacement height, assume d₀=0m
zero-plane displacement height, assume z₀=0m

H=Rₙ−U−Eₚ (5)

Determining evaporation then becomes an iterative process where a neutral stability value (L>0) may be chosen and the equations solved for Eₚ. The process may be repeated until the estimates for Eₚ converge. For stable conditions, L>>0 and ψₘ=ψᵥ.

By analyzing data from multiple systems 100, a more accurate understanding of specific conditions such as evaporation rate may be presented allowing for better management of the canal. For example, in portions of a given canal experiencing high rates of water evaporation, a temporary shade structure may be deployed in an effort to reduce the evaporation rate. When conditions change, the shade structure may be deactivated. When correct value for L is chosen, latent heat equation, λE, will be balanced.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to an exemplary embodiment. However, changes and modifications may be made to the exemplary embodiment without departing from the scope of the present technology. These and other changes or modifications are intended to be included within the scope of the present technology.

1. A system for measuring water characteristics from an open canal, comprising:
a base disposed along a side of the open canal;
an instrument arm coupled at a first end to the base and having a second end extending outward over the open canal;
a first data collection device disposed at the second end of the instrument arm, wherein the first data collection device comprises:
a first environmental data station;
a radiation sensor;
a flow meter; and
a depth measurement device oriented to obtain a depth reading from the open canal;
a second data collection device coupled to the base proximate the first end of the instrument arm, wherein the second data collection device comprises at least one temperature sensor disposed below a surface level of the open canal;
a mast coupled to and extending upwardly from the base, wherein a second environmental data station is coupled to the mast above ground level; and
a data logger in communication with the first and second data collection devices and the second environmental data station.

2. A system for measuring water characteristics from an open canal according to claim 1, wherein the flow meter is disposed above the surface of the open canal and configured to measure a flow rate of the canal without being in contact with the water.

3. A system for measuring water characteristics from an open canal according to claim 1, wherein the depth measurement device is disposed above the surface of the open canal and configured to obtain the depth reading of the canal without being in contact with the water.

4. A system for measuring water characteristics from an open canal according to claim 1, wherein the first data collection device further comprises a temperature sensor configured to obtain a surface level temperature of the canal without being in contact with the water.

5. A system for measuring water characteristics from an open canal according to claim 1, wherein:
a third environmental data station is coupled to the mast above the second environmental data station by a first vertical distance; and
a fourth environmental data station is coupled to the mast above the third environmental data station by a second vertical distance.

6. A system for measuring water characteristics from an open canal according to claim 4, wherein:
the first and second vertical distances are equal;
the third environmental data station is rotated about the mast by a first angular degree; and
the fourth environmental data station is rotated about the mast by a second angular degree.

7. A system for measuring water characteristics from an open canal according to claim 1, wherein the second data collection device further comprises a tube housing the at least one temperature sensor.

8. A system for measuring water characteristics from an open canal according to claim 7, wherein the second data collection device further comprises a second and a third temperature sensor disposed within the tube, and wherein:
the second temperature sensor extends deeper into the canal than the first temperature sensor;
the third temperature sensor extends deeper into the canal than the second temperature sensor; and
the tube is perforated to allow water to flow over the temperature sensors.

9. A system for measuring water characteristics from an open canal according to claim 7, wherein the tube comprises a fixed installation location for each temperature sensor.

10. A system for measuring water characteristics from an open canal according to claim 1, further comprising a solar panel disposed at a top end of the mast.

11. A system for measuring water characteristics from an open canal according to claim 1, further comprising an antenna extending from a top end of the mast.

12. A system for measuring water characteristics from an open canal, comprising:
a base disposed along a side of the open canal;
an instrument arm coupled at a first end to the base and having a second end extending outward over the open canal;
a mast coupled to and extending upwardly from the base;
a plurality of environmental data stations, wherein:
at least two environmental data stations are coupled to the mast above ground level and spaced vertically apart from each other; and
at least one environmental data station is disposed proximate to a second end of the instrument arm;
a radiation sensor disposed proximate to the second end of the instrument arm;
a flow meter disposed proximate to the second end of the instrument arm;
a temperature sensor disposed proximate to the second end of the instrument arm and configured to obtain a surface level temperature of the canal;
a depth measurement device disposed proximate to the second end of the instrument arm and oriented to obtain a depth reading from the open canal;
a data collection device coupled to the base and comprising at least one temperature sensor disposed below a surface level of the open canal;
an antenna extending from a top end of the mast; and
a data logger in communication with the plurality of environmental data stations, radiation sensor, flow meter, depth measurement device, and the first and second temperature sensors.

13. A system for measuring water characteristics from an open canal according to claim 12, wherein the flow meter, depth measurement device, and temperature sensor of the first data collection device are disposed above the surface of the open canal and configured to collect data without being in contact with the water.

14. A system for measuring water characteristics from an open canal according to claim 12, wherein no environmental data station coupled to the mast is positioned directly above or below another environmental data station coupled to the mast.

15. A system for measuring water characteristics from an open canal according to claim 12, further comprising a solar panel disposed at a top end of the mast.

16. A system for measuring water characteristics from an open canal according to claim 12, further comprising a power supply configured to provide power to the data logger.

17. A system for measuring water characteristics from an open canal according to claim 12, wherein the data collection device further comprises a tube extending downwardly from the base into the canal and is configured to house the at least one temperature sensor.

18. A system for measuring water characteristics from an open canal according to claim 17, wherein the data collection device comprises three temperature sensor disposed within the tube, and wherein:
a second temperature sensor extends deeper into the canal than a first temperature sensor;
a third temperature sensor extends deeper into the canal than the second temperature sensor; and
the tube is perforated to allow water to flow over the temperature sensors.

19. A system for measuring water characteristics from an open canal according to claim 17, wherein the tube comprises a fixed installation location for each temperature sensor.
